(19) United States
(12) Patent Application Publication
(10) Pub. No.: US 2023/0175514 A1
(43) Pub. Date: Jun. 8, 2023

(54) ELECTRONIC SPEED REGULATOR HAVING A BUILT-IN FAN

(71) Applicant: Shenzhen Hobbywing Technology Co., Ltd., Shenzhen (CN)

(72) Inventors: Youhui Liu, Shenzhen (CN); Yunlou Yang, Shenzhen (CN)

(21) Appl. No.: 17/981,688

(22) Filed: Nov. 7, 2022

Related U.S. Application Data
(63) Continuation of application No. PCT/CN2021/115679, filed on Aug. 31, 2021.

(30) Foreign Application Priority Data
Nov. 20, 2020 (CN) 202022716415.2

(51) Int. Cl. F04D 25/06; F04D 19/00; F04D 29/58

(52) U.S. Cl. CPC F04D 25/06; F04D 19/002; F04D 29/582

(57) ABSTRACT

An electronic speed regulator having a built-in fan. The electronic speed regulator comprises an aluminum part (10),a frameless fan (20), and screws (30); the frameless fan (20) is mounted on the aluminum part (10) by means of the screws (30); the aluminum part (10) comprises a base (11) and a heat dissipation fence (12); the heat dissipation fence (12) is located at the top of the base (11); and at least one hole position structure region (121) consisting of several hole positions is formed in the outer side wall of the heat dissipation fence (12).

### CROSS-REFERENCE TO RELATED APPLICATION

This application is based upon and claims priority to Chinese Patent Application No. 202022716415.2, filed before China National Intellectual Property Administration on Nov. 20, 2020 and entitled “ELECTRONIC SPEED REGULATOR HAVING A BUILT-IN FAN,” the entire contents of which are incorporated herein by reference.

### TECHNICAL FIELD

The present disclosure relates to the technical field of fans, and in particular, relates to an electronic speed regulator having a built-in fan.

### BACKGROUND

Fans are mainly used in model cars, model airplanes, model boats, electric drones and the like products. These products operate in a complex environment, and impose stricter requirements on the heat dissipation capacity. Therefore, the fan is required to have a better air generation capacity.

At present, the air generation capacity of the fan is widely concerned in the industry of models.

### SUMMARY

To overcome the defect in the related art, the present disclosure is intended to provide an electronic speed regulator having a built-in fan.

To achieve the above objective, the present disclosure employs the following technical solutions:

An electronic speed regulator having a built-in fan, wherein it comprises an aluminum part, a frameless fan, and one or more screws; wherein the frameless fan is mounted on the aluminum part via the screws, and the aluminum part includes a base and a heat-dissipating fence, the heat-dissipating fence being disposed at a top portion of the base, and an outer side wall of the heat-dissipating fence being provided with at least one hole-structured region constituted by a plurality of holes.

With the above technical solutions according to the present disclosure, the heat-dissipating fence of the aluminum part quickly transfers heat; by the design of the frameless fan and under cooperation of the hole-structured region, a heat dissipation effect of the fan is effectively enhanced, and an air outlet duct is smooth, which provides structural conditions for improvements of the air generation capacity. In addition, by the design of embedding the frameless fan into the aluminum part, the product is innovative in design concepts and has a novel shape, and the problems of a poor heat dissipation capacity and air generation capacity of the conventional fans are addressed. Further, the product according to the present disclosure is compact in structure, is novel and innovative, and has high values of utility and marketing.

### BRIEF DESCRIPTION OF THE DRAWINGS

One or more embodiments are illustrated by way of example, and not by limitation, in the accompanying drawings, wherein components having the same reference numeral designations represent like components throughout. The drawings are not to scale, unless otherwise disclosed.

FIG. 1 is a schematic view of an electronic speed regulator having a built-in fan according to an embodiment of the present disclosure;

FIG. 2 is a schematic exploded view of the electronic speed regulator having the built-in fan according to an embodiment of the present disclosure;

FIG. 3 is a schematic structural view of an aluminum part according to an embodiment of the present disclosure;

FIG. 4 is a schematic structural view of a stator seat according to an embodiment of the present disclosure;

FIG. 5 is a schematic structural view of a fan according to an embodiment of the present disclosure.

### DETAILED DESCRIPTION

Embodiments of the present disclosure are described in detail with reference to attached drawings. However, the present disclosure may be implemented in a plurality of manners defined and covered by the appended claims.

In a conventional fan, screws are locked on an aluminum part of an electronic governor, and a fan body is disposed outside. The fan has a frame, and thus does not have a smooth air duct.

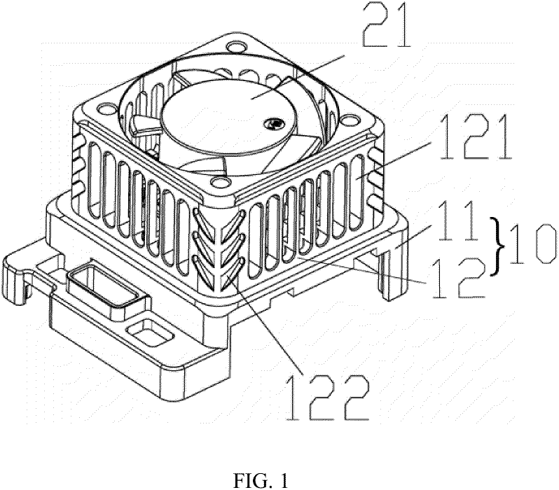

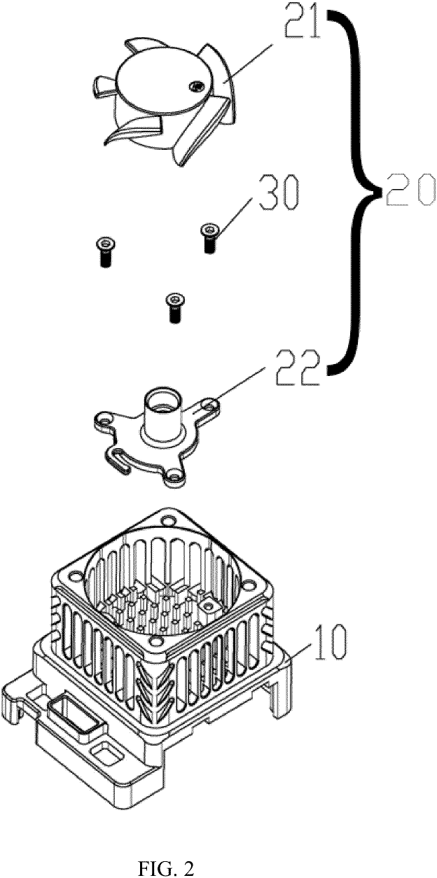

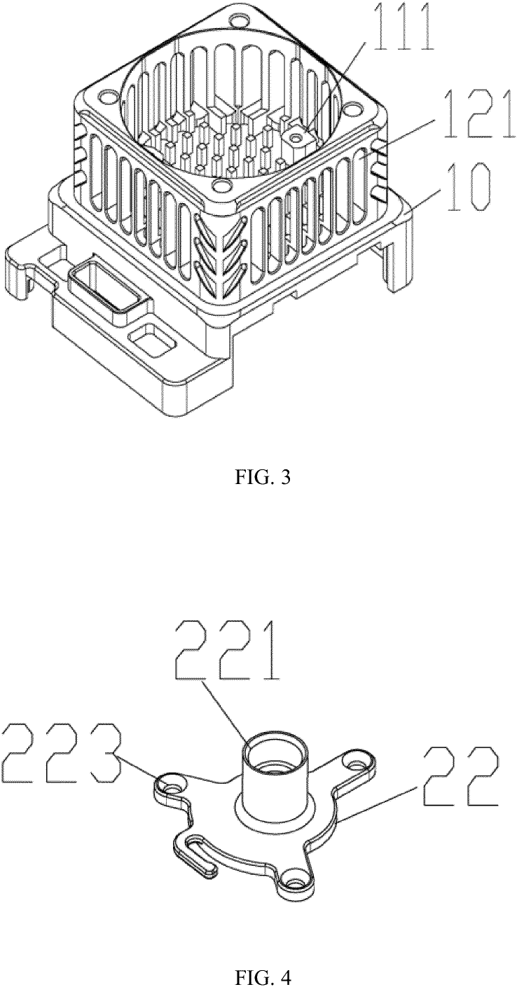

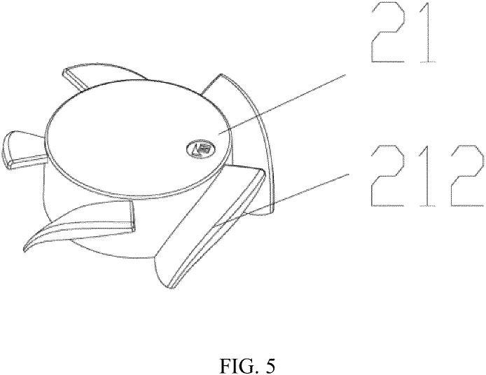

As illustrated in FIG. 1 to FIG. 5, an electronic speed regulator having a built-in fan according to an embodiment includes: an aluminum part 10, a frameless fan 20, and screws 30; wherein the frameless fan 20 is mounted on the aluminum part 10 via the screws 30, and the aluminum part 10 includes a base 11 and a heat-dissipating fence 12, the heat-dissipating fence 12 being disposed at a top portion of the base 11, and an outer side wall of the heat-dissipating fence 12 being provided with at least one hole-structured region 121 constituted by a plurality of holes.

According to the present disclosure, the heat-dissipating fence 12 of the aluminum part 10 quickly transfers heat; by the design of the frameless fan 20 and under cooperation of the hole-structured region 121, a heat dissipation effect of the fan is effectively enhanced, and an air outlet duct is smooth, which provides structural conditions for improvements of the air generation capacity. In addition, by the design of embedding the frameless fan into the aluminum part, the product is innovative in design concepts and has a novel shape, and the problems of a poor heat dissipation capacity and air generation capacity of the conventional fans are addressed. Further, the product according to the present disclosure is compact in structure, is novel and innovative, and has high values of utility and marketing.

In some embodiments, the base 11 and the heat-dissipating fence 12 are both aluminum structural body, and the base 11 and the heat-dissipating fence 12 are integrally formed such that the base 11 and the heat-dissipating fence have a better heat dissipation effect. The aluminum material has a better thermal conductivity. Nevertheless, the material of the base 11 and the heat-dissipating fence 12 is not limited to aluminum, and the base 11 and the heat-dissipating fence 12 may also be made of other materials having good thermal conductivity.

In some embodiments, the hole-structured region 121 is a strip mesh-like structure constituted by a plurality of holes, which solves the problem of heat dissipation, and implements a smooth air outlet duct. Nevertheless, the strip mesh-like structure according to this embodiment may also be in other shapes, for example, honeycomb-shaped holes or the like, to achieve the objects of enhancing the heat dissipation effect of the fan and smoothening the air outlet duct.

For structural optimization, the frameless fan 20 includes a fan 21 and a stator seat 22; wherein a hollow cylinder 221 is formed at a center of the stator seat 22, the fan 21 is mounted on the hollow cylinder 221, one or more locking openings 223 are formed at an edge of the stator seat 22, one or more screw holes 111 is opened at a top of the base 11, and the one or more screws 30 pass through the one or more locking openings 223 and are connected to the one or more screw holes 111. The fan 21 is mounted on the stator seat 22 via the hollow cylinder 221, and the one or more screws 30 pass through the one or more locking opening 223 and are connected to the one or more screw holes 111, such that the base 11 and the stator seat 22 are fixedly connected. In this way, mounting by an assembler is facilitated, and a manufacturing effect is improved.

For further structural optimization, the locking openings 223 are distributed in an annular array on the stator base 22, such that a uniform force is achieved during mounting. Three locking openings 223 may be provided, such that fewer openings 223 are provided while the uniform force is achieved.

The fan 21 is provided with plastic blades 212. To be specific, the plastic blades 212 are disposed on a side wall of the fan 21.

To be more ornamental, slant grooves 122 are arranged at edges of corners of the heat-dissipating fence 12. The slant grooves 122, together with the hole-structured region 121, exhibit integrity of the entire product, thereby avoiding abruptness.

Described above are merely preferred embodiments of the present disclosure, which are not intended to limit the scope of the present disclosure.

Any equivalent structures or equivalent flowchart transformations made based on the specification and accompanying drawings of the present disclosure, even if being directly or indirectly applied to some other related technical fields, shall all fall within the protection scope of the present disclosure.

What is claimed is:

1. An electronic speed regulator having a built-in fan, comprising: an aluminum part, a frameless fan, and screws; wherein the frameless fan is mounted on the aluminum part via the screws, and the aluminum part comprises a base and a heat-dissipating fence, the heat-dissipating fence being disposed at a top portion of the base, and an outer side wall of the heat-dissipating fence being provided with at least one hole-structured region constituted by a plurality of holes.

2. The electronic speed regulator having the built-in fan according to claim 1, wherein the base and the heat-dissipating fence are both an aluminum material structure, and the base and the heat-dissipating fence are integrally molded.

3. The electronic speed regulator having the built-in fan according to claim 1, wherein the hole-structured region is a strip mesh-like structure constituted by a plurality of holes.

4. The electronic speed regulator having the built-in fan according to claim 1, wherein the frameless fan comprises a fan and a stator seat; wherein a hollow cylinder is formed at a center of the stator seat, the fan is disposed on the hollow cylinder, locking openings are formed in an edge of the stator seat, the top portion of the base is provided with screw holes, and the screw pass through the locking openings and are connected to the screw holes.

5. The electronic speed regulator having the built-in fan according to claim 4, wherein the locking openings are distributed in an annular array on the stator seat.

6. The electronic speed regulator having the built-in fan according to claim 4, wherein a side wall of the fan is provided with plastic blades.

7. The electronic speed regulator having the built-in fan according to claim 1, wherein slant grooves are disposed at edges of corners of the heat-dissipating fence.
